(19) United States
(12) Patent Application Publication
(10) Pub. No.: US 2015/0259931 A1
(43) Pub. Date: Sep. 17, 2015

(54) Construction Hoist Strap and Method

(71) Applicant: Arthur Charles Doerscher, SR., Niles, MI (US)

(72) Inventor: Arthur Charles Doerscher, SR., Niles, MI (US)

(21) Appl. No.: 14/205,743

(22) Filed: Mar. 12, 2014

(51) Int. Cl. E04G 21/16; B66C 1/14

(52) U.S. Cl. CPC E04G 21/16; B66C 1/14

(57) ABSTRACT

A building construction tool strap for lifting and setting building trusses or the like that has either a single or multiple straps or a main strap with multiple attachment points or hooks on the main line or a ring with multiple straps attached to it for lifting multiple trusses at a single time and installing them, one after the other, where as the first truss to be attached to the strap(s) is the last to be installed on the building walls or roof, where as the last truss attached to the strap(s) that would be the lowest on the strap(s) or the longest strap(s), or in other words, when all the items are suspended in the air, the last item attached to the longest strap or the lowest on the main strap or on the main ring is the first installed on the building. When all the trusses are lifted and then lowered at one time, they would be installed on the building in sequence. The trusses would be hung in such a way so as not to be over the head of the installers. The trusses are attached in reverser order as they are installed on the building walls or roof and would be in numerical order, no matter what their size, they would be attached to the strap(s) in order so that the last truss attached to the longest strap(s) and is the lowest when suspended in the air, would be the first to touch down on the building walls or roof when all the trusses are lowered and be installed on the top of the walls or roof, then the items would be installed one after the other, in sequence saving both time and man hours.

When a home or building is constructed there are usually pre manufactured trusses that are shipped to the job site instead of the workmen building them by hand on the job site because the trusses can be manufactured in a very economical fashion. The truss builders use a plate that has slots stamped into it where as the slots are only cut with an opening on one end, the other end bends making fingers that when pressed on to several pieces of wood, joins those pieces together creating a very substantial bond or union with great holding strength and since trusses sometimes are of the same size and shape, these can be manufactured and shipped in a very cost effective manner. Many homes and building today use pre manufactured trusses.

However when the trusses are in large number and are on the ground at the job site they usually must be lifted by a large crane with a boom in order to place them in the proper sequence and at the proper location on the walls or roof of the building.

The usual manner of lifting the trusses is to have a workman stand by the stack of trusses, and when the crane operator swings the boom around there is attached to the boom, via a cable or rope a hook that the workman attaches to a single truss, beam or what ever object is being installed on the building. Then the crane operator lifts the one truss up and at the same time swings the boom to where two or more workmen are on the walls, usually one on each side and at least one is in the middle, depending on the size of the truss or object and the one in the middle installs a bar of predeteimined length between each of the trusses that holds the top of the trusses from tilting forwards or backwards. Then, the other workmen on the walls attach the ends of the truss to the top of the walls or roof, then, the man in the middle releases the lifting strap(s).

Then the crane operator is signaled to swing the boom back over to the workman on the ground where he attaches another single truss to the strap(s) and the operation is repeated until all the trusses are installed on the walls or roof creating a roof or other structure(s).

Since only one truss in lifted and installed on the walls or roof of the building at a time, a great deal of time is lost in man labor waiting for the next truss to be brought up.

All the time a worker is usually standing on the ground or on the truck waiting for the truss to be installed and the boom and strap to be swung back for him to attach the next truss.

This is an enormous waste of time. There is a need for a multi strap truss lifter that is forgiving in nature, that can compensate for the wide variety of shapes and sizes of trusses, that can be safely and quickly attached to and lift multiple trusses at a time, saving on man hours, lowering the number of men needed for the job and eliminate a great deal of the time the crane is rented and is swung back and forth for each individual truss.

It would be possible for one worker, with the aid and assistance of this novel invention, to attach multiple trusses on to a single, main line, or set of lines and that same worker could now climb up on to the walls or roof and install multiple trusses in one setting, cutting the fatigue and time of climbing up and down the walls or roof for each truss or having an individual waiting by the trusses in order to install each one after the previous one is installed and saving the time that the crane operator spends swinging the boom back and forth.

### METHOD

The crane operator would have the workman lay the straps on the trusses next to the balance point of each truss, then, with the hooks between the main strap and the trusses, the workman would attach the hooks to the trusses in reverse order that the trusses are to be installed on the walls or roof, then he attaches the first truss strap that is highest on the main strap first, because this truss is going to be set into place on the wall or roof last, in other words, the first truss picked up by the main strap will be suspended the highest on the main strap after all the trusses are suspended in the air. Then the workman attaches the next strap that is next in line and lower on the main strap, to the next truss that will be the second to the last to be, installed on the walls or roof.

This procedure is repeated until all of the trusses are attached, so that the last truss attached to the main strap is the lowest hanging and the first to be lowered on to the walls or roof and installed.

So when a crane operator swings the boom over to the trusses, he has a workman attach the main strap hook or ring to the crane hook,

The trusses will be vertically pivotal, with or without a bearing, so that the trusses suspended on up the line will be away from or on the other side of the lowest hanging truss or item, then the first truss is lowered into position, it is attached to the walls or roof then the next truss is lowered all the way down on to the walls or roof with the workers positioning the next truss into place as it is being lowered, keeping the previously set truss between the workers and the trusses that is being lowered and set into position so that the trusses still in the air, would not be over the head of the installers on the walls or roof, or the installers on the top of the trusses, setting the top of the trusses.

Then the workers would step over or through the truss that is already attached to the walls or roof to finish attaching the next truss that has just been lowered on to the walls or roof. Then the crane operator lowers the next truss down on to the walls or roof, that is already in the air over the walls or roof, makes a slight adjustment to the boom so as to properly position the truss on to the walls or roof, and lowers the next truss all the way down, on to the top of the walls or roof, with out having to;
1. Raise the straps up,
2. Swing the boom back over to where the other trusses are still on the ground or truck,
3. Have another worker attach the next truss, or have a worker that is on the walls or roof come down and attach the next truss on to the line, then, have that worker climb back up on the walls or roof,
4. Raise the next truss,
5. Swing the boom over to where the next truss needs to be installed,
6. Lower the next truss in place and or among other things.

The multi attaching, lifting and installing of the trusses on to the walls or roof would be repeated till all are installed on the building.

The hooks on the main line would be on the same side or both sides of the main line(s), in any arrangement depending on the need;

Or the main line would not have hooks but would have attachment points that auxiliary straps would be attached to;

The one end of the auxiliary straps would be attached to a main line attachment point; where as the other end of the auxiliary straps would be attached to the trusses or items.

At times, multiple straps would be used on each truss because of large or odd shapes where the balance point of the truss would or would not be off set, these straps would be of different lengths and sizes, in any arrangement or combination as the need may be.

After the truss has been set and fastened to the walls or roof, there would or would not be a place for the hooks that have been removed from the trusses to be attached to, either on the main or auxiliary straps. There would or would not be a covering or shield to cover the stored hooks so that when the crane operator is finished with any given set of trusses and he picks the lines up for another set or the job is done, the hooks would not become entangled, or get caught on any of the trusses and they would be out of the way of the truss installers.

In another embodiment of this invention, the individual auxiliary straps would be “detachable” from the main strap. The main strap attachment points would be either hooks, rings or loops, devises or any other attachable arrangement and the auxiliary strap end that attaches to the main strap would be a hook, ring or loop to attach itself on to the main strap attachment point, either to be removable or replaceable for other types of straps with any attachable device, but also to be removed to be out of the way so as not to become entangled on the trusses or rafters or any other item after these items have been installed on the building.

The main strap would be removable from the crane hook. Any detachable straps, after they have done their job, either the main strap with all the auxiliary straps attached to it or just the auxiliary straps would be passed down to the ground workman to attach to the next set of trusses. Then while the installers are attaching the remaining trusses to the walls or roof, these straps or another set of straps can be attached to another set of trusses to save time so that when the first load is finished being installed and affixed on the walls or roof, all the crane operator needs to do is swing the boom around for another load and have these immediately attached to the crane hook.

In another embodiment of this invention, the auxiliary straps would or would not also have multiple attachment points on them and or, both ends would terminate in a hook, loop, ring or any other attachable arrangement so that other straps weather they be main or auxiliary straps, could be attached to them as the need may be.

In another embodiment of this invention, the main strap would have a ring or hook on one or on both ends, so that additional main straps with other auxiliary straps, coming off of it, could be added when needed to lift larger numbers of trusses at one time and at times, a plurality of trusses or items would be attached to any one or multiple set of straps.

The hooks at any location on any of the straps would be large enough to hook on to the apex or balance point or any other attachment points of the trusses or be made in such a way that the hook and strap would be passed under or through the truss, at the most advantageous location on the trusses, and then the hook would be attached to its own or any other line, forming a loop with safety devices to hold the hooks in place till the workmen physically removes them.

In another embodiment of this invention, the hook would be in the form of a large hook, or clamp. If a clevis is used the pin would be pulled out or unscrewed and removed in order for the workman to attach the clevis and strap to the trusses, in any arrangement and then be removable after the trusses or items are affixed to the walls or roof.

The straps, when there would be all on one main strap arrangement, single or plural for each length, or multiple straps on a main ring, each strap would have a number, color or texture or any combination thereof for the worker to distinguish the correct order of sequence that the trusses or any other items would be in, in order to have them in correct alignment, orientation and or sequence when they are in the air suspended over the walls or roof and when they are lowered, the correct truss would be in position to be installed and affixed at the correct place on the walls or roof.

In another embodiment of this invention, there would be a main ring, with multiple straps, at least one for each truss. Each strap or set of straps would be of a different length for each consecutive truss, lifting at least one truss for each strap or set of straps. Also the straps sometimes would be adjustable as to length as the case may be needed and at times the straps would have an elastic characteristic to them to help balance the amount of weight each strap would carry and make handling the trusses easier for the installers because they would be able to shift or rock them from side to side as needed to align them to the walls or roof. In this configuration, each strap would be single or multiple, and anywhere along its length, there would or would not be attachment points for additional main or auxiliary straps, in any combination or configuration.

In one embodiment of this invention, there would be a swivel between the hook on the crane and the straps, which ever straps they may be so that the trusses could be turned or oriented to the wall or roof and the last truss picked up, which would be the one hanging the lowest on the main line or on the longest straps and in the string of trusses and would be the first to be set into place without the other trusses hanging over the head of the installers.

In another embodiment of this invention, the main strap and the auxiliary straps coming off of the main strap as well as straps coming off of the auxiliary straps, not shown, to hold large and very wide trusses or items, all these straps would be made of steel wire rope, chain links, or Kevlar or nylon or any combination there of or any other materials that would be economical and or of sufficient strength to accommodate the loads placed on it.

There are straps that have a series of loops such as a gun bullet holder where a belt or strap holds numerous bullets; however these simply hold the item for when they are needed, not to assist in installing an item in any sequence of order or for raising or lowering into place as in the case of constructing a building.

2717801 is a jig for lifting multiple rafters at one time however this rack is very unforgiving in nature because the rack would need to be reconstructed to compensate for different shapes of trusses where the inner configurations of trusses must at times, be custom designed for any particular structure, there is no guarantee that the truss shape would match the ridged racks attachment points and if the truss should shift off to one side the truss would become unstable, and if the workmen needed to pull down on one end in order to install or align the truss or member to one side, this could lift the other end of its carrier contact point, possible removing the other end from its cradle, however with straps that hook on to or wrap around the truss and are secured with safety devices incorporated into the hooks or attaching apparatuses, these would not become unhooked when, inevitably a workmen would push, pull, tilt and align either side or end to the installation point(s) they would be with out fear of the other end becoming unattached. The straps with or without length adjustability, or elasticity, would be attached to the fulcrum points or over a wide area of the truss.

Even if different lengths of straps were needed, this would prove no problem because the longer or shorter straps would only need to be attached to the main line or main ring attachment points and if there were a wind, or the trusses are bumped or jarred, the straps would be securely attached to the trusses and would not allow it to shift off to one side and the strap(s) would not become unattached until they were physically removed by the workmen.

Also, if there were some ceiling joists already installed, the rigid lifting frame would be in the way if trusses were to be installed, because the rigid frame must descend down below the previously installed rafter or truss also, there is no mention of a sequence, which is critical because in any building, all the members can be of different length, thicknesses, heights and weights or configurations and with the preferred embodiment of this invention, all can be accommodated by different locations on the main straps or on the main ring, or on different locations on the items being lifted in conjunction with the employment of any number and lengths of straps and with the availability and the capacity of adding on additional straps, different sizes of building materials can be accommodated. Also, with new types of building members that are constructed in new and novel ways as well as with new materials, longer and heaver members are being employed where any length of these items can be created according to an engineers request, to construct larger and better buildings, these member are sometimes far to large to be safely handled physically by workmen.

These also would be placed into position by the use of these lifting straps, in sequence and in multiple numbers. The auxiliary straps on the main line or ring, being single or plural would then have additional straps coming off of it, or in other words, each main or auxiliary strap would or would not have a singe or plural attachable device on one end and terminate in a single hook, ring, loop or any other attachable device on the other end or would have multiples ending straps on each of these main or auxiliary straps with any single or multiple attachable devices and there would be at least one on each side as well as the main auxiliary strap extending down, in any configuration so that the item to be installed would be held with at least one, two, three or more attachment points on each item to be installed, not shown.

6093070 id a life saving strap suspended between two lifting devices, not one and has a lifting area straight across level to the waters surface, not down, lifts all straight across, needs a third center lifting strap to hold it level, when there is a heavy load and there is no mention of dropping each on the deck one after the other and only works if there are two winching devices to pull the main strap taunt to provide the lifting means, said shackles are not hooks which cannot be wrapped around a devices and reattached to its own line creating a secure loop so that the load cannot become unattached by wind, vibration, or any other gyrations and the items are not intended to be installed in sequence.

### BRIEF DESCRIPTION OF THE PREFERRED EMBODIMENT

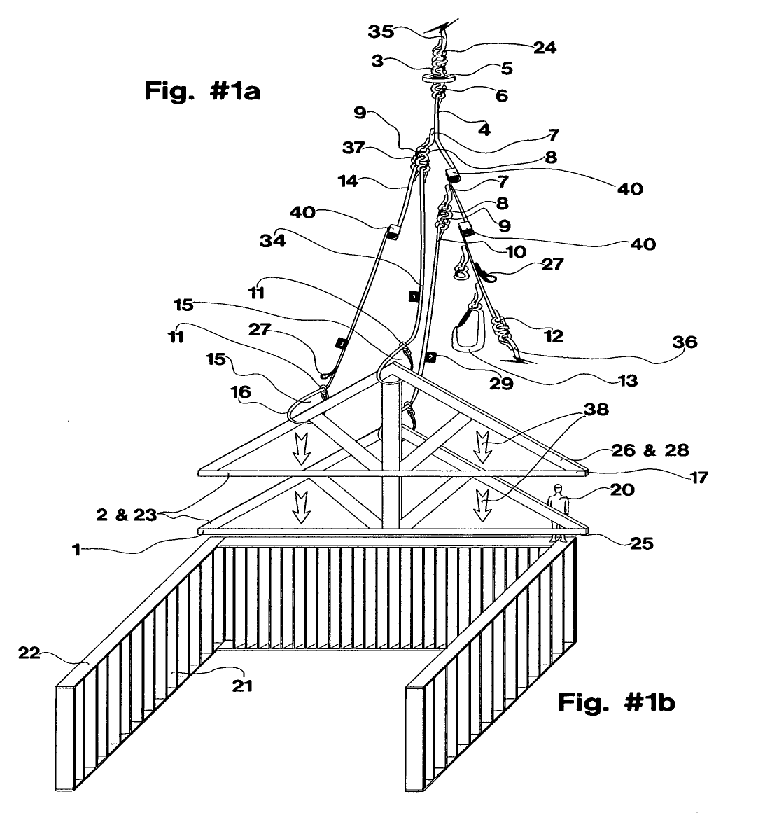

FIG. 1A, is a side ways view of a main strap with multiple attachment points with auxiliary straps hooked to the attachment points and these secondary auxiliary straps would hook on to or be wrapped around a truss or similar item and be hooked on to its own or the same strap or a different attachment point creating a secure loop and also the main strap, with or without an additional hook or ring on the termination point in case another strap was needed to be attached to the number one main strap for any reason.

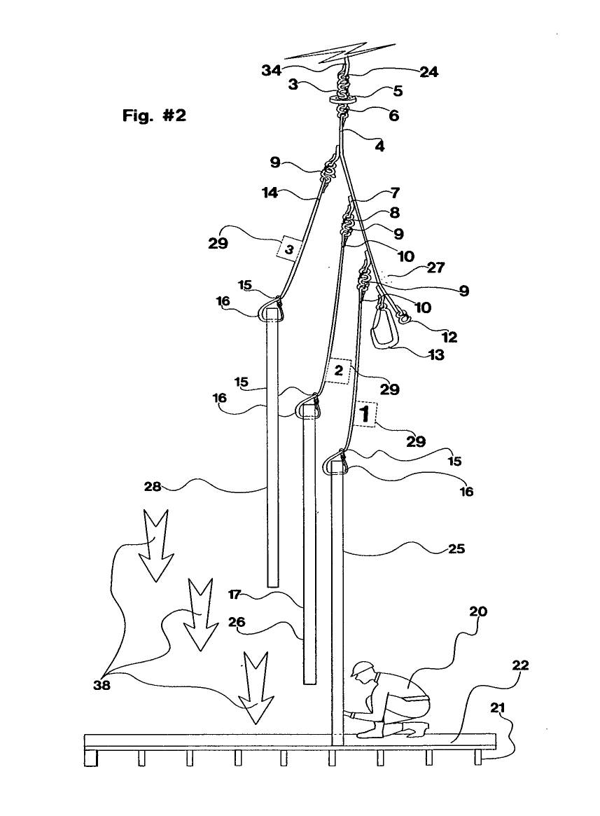

FIG. 2 is a frontal view of a main strap, with several roofing rafters suspended on the main strap via multiple auxiliary straps that are wrapped around the apex or other necessary attachment points on the trusses, with at least one strap per truss and, each attachment point on the truss achieved by at least one hook onto or wrapped around the truss, with the number one roofing truss to be installed on the top of the walls or roof, being the one picked up last, that is hanging the lowest, and also an indicator for where the truss installers would be located without the next truss being over their head with or without a main line termination point as an add on hook or ring.

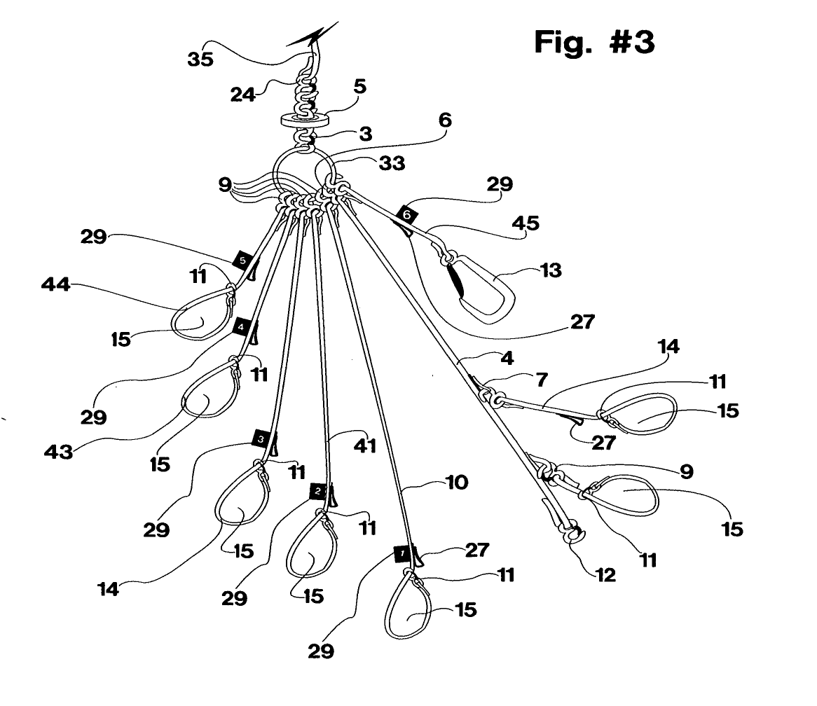

FIG. 3 shows a building under construction with the walls made of studs, with three trusses being suspended, each truss is attached to the main line by a single auxiliary strap being lowered down in correct numerical order on to the top of the walls with the first truss to be installed hanging the lowest on the main strap so that they could be installed in succession without having to move the crane back and forth for each truss and an indicator as a x to show where the installers would be positioned on the walls without the next truss being over their heads.

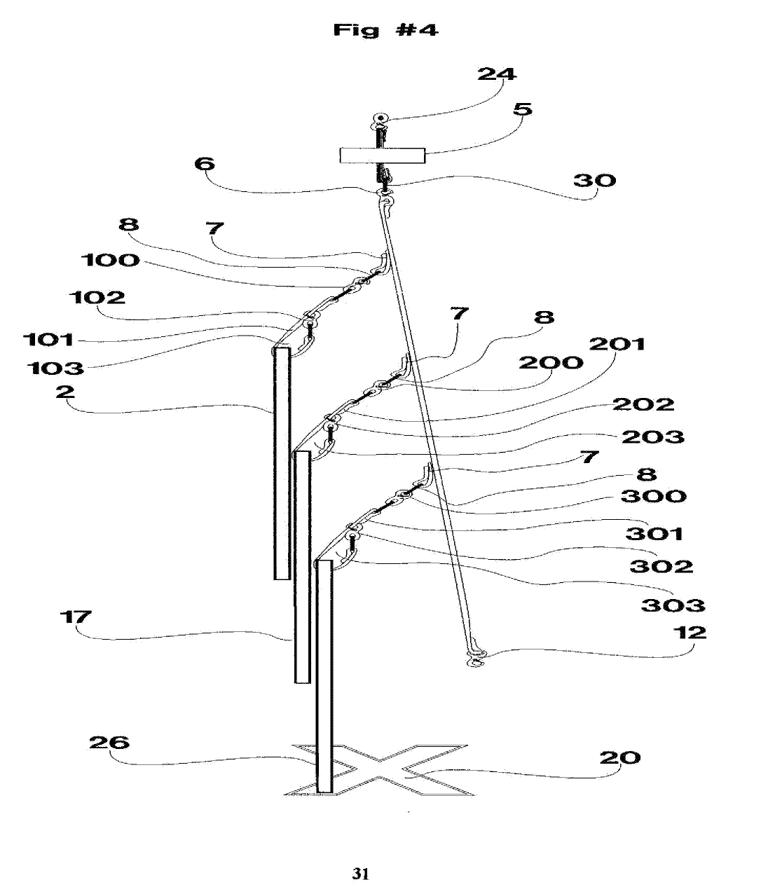

FIG. 4 is a side ways view of a main strap hooked on to a crane hook that has a swivel or bearing to allow the trusses to be vertically pivotal to orient the trusses to the walls or roof with multiple attachment points on the main line with several auxiliary straps, at least one for each truss, wrapped around each truss and hooked on to its self creating a loop around the truss, and where the installers would stand in relationship to the lowest and first truss to be installed on the walls or roof and how the next trusses would not be over the installers heads with an add one hook or ring for extra main or auxiliary lines, if needed.

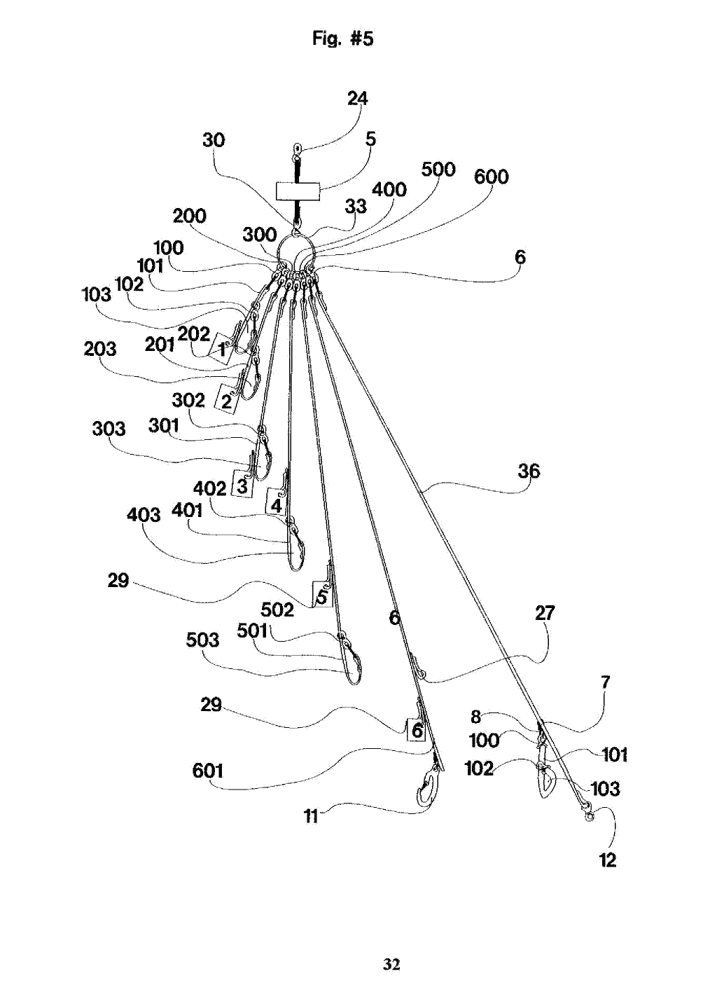

FIG. 5 shows a hook from a crane, a swivel to vertically pivotal and orient the trusses to the job, a hook on to the bottom of the swivel ring to attach a large ring, on to which are hooked multiple straps, each a different length with a hook large enough to hook directly on to a rafter or the strap would be passed under the rafter attachment point and the hook be attached to its own strap or the most advantageous location on the auxiliary or main straps or main ring or crane hook, creating a secure loop and additional loops on each strap to store the detached hook or for additional straps to be attached to the auxiliary straps, and each strap is numbered or configured for identification and at least a single strap for at least one truss or item to be lifted or multiple straps for each truss of the same or of different lengths as the case may be for even or odd shaped trusses plus an extension strap to attach additional straps that has a ring or attachment point down below the termination point of the other main or auxiliary straps to transfer weight more evenly in the case of additional main lines or auxiliary straps are needed.

### DETAILED DESCRIPTION OF THE PREFERRED EMBODIMENT

The novel concepts encompassed within this preferred embodiment of this invention is further described in the following;

FIG. 1, shows the crane hook, 24, the upper and lower swivel hooks, 3, the swivel, 5, the main strap, 4, the main strap top hook, 6, with multiple auxiliary truss strap attachment points, 7, with its attachment rings, 8, with the first auxiliary strap with its top hook, 100, attached to the auxiliary strap ring, 8, the first auxiliary strap, 101, the first auxiliary strap bottom hook, 102, hooked either directly on to the truss or item to be installed or on the auxiliary strap, 101, making a loop, 103, that would go around the most advantageous point(s) on a truss for supporting and lifting of the trusses or a large hook, 34, attached to the main line, 4, would be large enough to hook directly on to a truss member, or be wrapped around the most advantageous point on a truss or item, then hooked on to its own strap or any advantageous location, creating a loop, as well as a main line end hook, 12, to add on more main or auxiliary straps in the case of a larger number of trusses are to be set, installed and affixed. Also a second auxiliary strap, 201 attached to the main line, 4, to be attached to a truss, not shown, in the same manner as the first auxiliary strap, also a third auxiliary strap, 301 attached to the main line, 4, to be attached to a truss, not shown in the same manner as the first auxiliary strap.

FIG. 2, shows a crane hook, 24, the swivel, 5, that would make the load vertically pivotal to orientate the stack of rafters to the walls or roof for proper sequence of installation, the swivel ring, 30, the main strap, 4, the main strap top hook, 6, an auxiliary truss strap attachment points, 7, with its auxiliary truss strap ring, 8, with the first auxiliary truss strap top hook, 100, hooked on to the auxiliary truss strap ring 8, the first auxiliary truss strap, 101, as it wraps around an advantage point on the highest truss, 2, or last truss to be installed on the walls or roof, the first auxiliary truss strap bottom hook, 102, hooked on to the first auxiliary strap, 101, however this hook could be attached to another object or location if that would present a better and safer arrangement, the first auxiliary truss strap wrapped around the truss, creating a loop, 103, on the truss, 2. However, the main strap(s) or the auxiliary straps would or would not be adjustable as to length, not shown, and or have an elastic characteristic so that the pressure on each strap automatically compensates to each strap to better hold the trusses or items to be installed, especially where the trusses are of odd shapes or extra large and there would be extra support for the trusses by extra attachment points, 7 & 8, on the main strap, 4, and on the auxiliary straps, not shown, and on the truss itself as shown by a second auxiliary strap top hook, 200. This is hooked on the main line attachment points, 7 & 8, with the second auxiliary truss strap, 201, as it wraps around an advantage point on the top of the last truss to be installed on the walls or roof, the second auxiliary truss strap bottom hook, 202, hooked on to the second auxiliary truss strap, 201, the second auxiliary truss strap wrapped around the truss, creating a loop, 203, where as, if needed, and there would be extra support for the trusses by extra attachment points on the main strap, 4, & 7 & 8, or multiple straps on a single attachment point on the main strap attachment point, 8, and on the truss itself as shown by a third auxiliary strap top hook, 300, hooked on the main line attachment points, 7 & 8, with the third auxiliary truss strap, 301, as it wraps around an advantage point on the top truss or the last truss to be installed on the walls or roof, the third auxiliary truss strap bottom hook, 302, hooked on to the third auxiliary truss strap, 301, the third auxiliary truss strap wrapped around the truss, creating a loop, 303 for wide spread weight distribution and compensation. Also shown is a second truss, 17, suspended on the main line, 4, with its own straps, hooked on the main line attachment points, 7 & 8, with the second truss, forth auxiliary strap top hook, 400, hooked on the main line, 4, on another main line attachment point, 7, & 8, as it wraps around an advantage point on the lowest or first truss to be installed on the walls or roof, 401, the forth auxiliary truss strap bottom hook, 402, hooked on to the forth auxiliary truss strap, 401, the forth auxiliary truss strap wrapped around the truss, creating a loop, 403, also shown in another strap supporting the second truss, 17, the fifth auxiliary strap top hook, 500, hooked on the main line, 4, the fifth auxiliary truss strap, 501, as it wraps around an advantage point on the lowest or first truss to be installed on the walls or roof, the fifth auxiliary truss strap bottom hook, 502, hooked on to the fifth auxiliary truss strap, 501, the fifth auxiliary truss strap wrapped around the truss, creating a loop, 503. Also shown is another strap supporting the second truss, 17, the sixth auxiliary strap top hook, 600, hooked on the main line, 4, & 7 & 8, the sixth auxiliary truss strap bottom hook, 602, booked on to the sixth auxiliary truss strap, 601, the sixth auxiliary truss strap wrapped around the truss, creating a loop, 603, as it wraps around an advantage point on the lowest or first truss to be installed on the walls or roof, and there would be as many trusses as the line can hold or in this presentation, this last mentioned truss will be the first truss that would be installed on the walls or roof, suspended on the main strap, 4, also the lowest truss, 17, would be behind the first truss, 2, and be between the upper suspended trusses and the installers with an “X”, 20, showing where the truss installer would be positioned on the top of the walls or roof so that the trusses are not over the head of the installer(s) in relationship to the next truss that is suspended over head 2, and would be installed away from the installer, also there would or would not be a safety wind strap holding the trusses together in case of wind(s), not shown also a main strap bottom hook, 12, to add on additional strap(s) for larger numbers of trusses.

The next drawing is essentially the same as the preceding, however for a clear understanding of the concepts encompassed within the preferred embodiment of this invention, the following is provided;

FIG. 3, shows the crane hook, 24, the swivel, 5, the swivel ring, 30, the main strap top hook, 6, the main strap, 4, an auxiliary truss strap attachment points, 7, with its attachment ring, 8, with the first single auxiliary truss strap top hook, 100, hooked on to the main truss strap, attachment point and ring, 7& 8, the first auxiliary truss strap, 101, as it wraps around an advantage point on the truss, the first auxiliary truss strap bottom hook, 102, hooked on to the first auxiliary strap, 101, the first auxiliary truss strap wrapped around the truss, creating a loop, 103, for the last truss, 2, that would be installed on the walls or roof because it would be the highest suspended on the main line, 4. The main strap(s) or the auxiliary straps would or would not be adjustable as to length, not shown, and or have an elastic characteristic so that the pressure on each strap automatically compensates and helps shift the weight evenly to each strap to better hold the trusses or items to be installed, especially where the trusses are of odd shapes or extra large and there would be extra support needed for the trusses by extra attachment points on the trusses and extra straps, not shown. All of the trusses and auxiliary straps are on the main line, 4. The main line, 4, also shown holding the next truss, 17, here shown suspended by a single second auxiliary strap top hook, 200, hooked on the main line attachment points, with the second auxiliary truss strap as it wraps around an advantage point on the truss, 201, the second auxiliary truss strap bottom hook, 202, hooked on to the second auxiliary truss strap, 201, the second auxiliary truss strap wrapped around the truss, creating a loop, 203 All the trusses shown in this presentation would be in numerical order, according to size, or order of installation or for any other reason. The main line is also shown holding the next or third truss, 26, the lowest and first to be installed on the walls or roof. shown here as 26, here shown suspended by a single third auxiliary strap top hook, 300, hooked on the main line attachment points, with the third auxiliary truss strap, 301, as it wraps around an advantage point on the truss, the third auxiliary truss strap bottom hook, 302, hooked on to the third auxiliary truss strap, 301, the third auxiliary truss strap wrapped around the truss, creating a loop, 303, and there would be as many trusses as the line can hold or as many as needed, and the “X”, 20, is where the worker would be positioned so that he could install the trusses on the walls or roof in proper sequence without having to stand under the next trusses still suspended in the air and ready to be installed next, 2, 17 & 26, as well as a main line end hook, 12, to add on more main line straps in the case of a larger number of trusses are to be set, in this presentation, on the walls, 21, that has a top sill, 22, for the trusses to be attached to.

FIG. 4, is a sideways view showing a crane hood, 24, the swivel, 5, the swivel ring, 30, the main strap top hook, 6, the main strap, 4, with trusses suspended in the air, 2, 17, 26, an auxiliary truss strap attachment points, 7, with its attachment ring, 8, with the first single auxiliary truss strap top hook, 100, hooked on to the main truss strap, 4, attachment point ring, 8, the first auxiliary truss strap, 101, as it wraps around an advantage point on the truss, the first auxiliary truss strap bottom hook, 102, hooked on to the first auxiliary strap, 101, the first auxiliary truss strap wrapped around the truss, creating a loop, 103 around the last truss, 2, that would be installed on the walls or roof because it would be the highest suspended on the main line. The main line, 4, also is holding the next truss, 17, here shown suspended by a single second auxiliary strap top hook, 200, hooked on the main line attachment points, 7 & 8, with the second auxiliary truss strap, 201, as it wraps around an advantage point on the truss, the second auxiliary truss strap bottom hook, 202, hooked on to the second auxiliary truss strap, 201, the second auxiliary truss strap wrapped around the truss, creating a loop, 203. The main line, 4, also is holding the next or third truss, 26, the lowest and first to be installed on the walls or roof shown here as 26, here shown suspended by a single third auxiliary strap top hook, 300, hooked on the main line attachment points, 7 & 8, with the third auxiliary truss strap, 301, as it wraps around an advantage point on the truss, 17, the third auxiliary truss strap bottom hook, 302, hooked on to the third auxiliary truss strap, 301, the third auxiliary truss strap wrapped around the truss, creating a loop, 303, and there would be as many trusses as the line can hold or as many as needed, and the “X”, 20, is where the worker would be positioned so that he could install the trusses on the walls or roof in proper sequence without having to stand under the next trusses still suspended in the air and ready to be installed next, 2, 17 & 26, as well as a main line end hook, 12, to add on more main line or auxiliary straps in the case of a larger number, of trusses are to be set.

FIG. 5 is an adaptation of the proffered embodiment and this, drawing shows a crane hook, 24, with a swivel, 5, and in this case, the swivel would have a hook, 39, so that the load would be vertically pivotal and the workers can turn and orientate the trusses in the proper order of installation, a large ring, 33, that has multiple single auxiliary straps, with the first auxiliary truss strap top hook, 100, hooked on to the main ring, 33, with the first auxiliary strap as it would wrap around an advantage point on the truss, not shown, the first auxiliary truss strap bottom hook, 102, hooked on to the first auxiliary strap, 101, creating a loop, 103 around the last truss, not shown, that would be installed on the walls or roof because it would be the highest suspended and attached to the large ring instead of a single main strap, (not shown), with the second auxiliary truss strap top hook, 200, hooked on to the main ring, 33, with the second, auxiliary strap, 201, as it would wrap around an advantage point on the truss, not shown, the second auxiliary truss strap bottom hook, 202, hooked on to the second auxiliary strap, 201, creating a loop, 203 for the truss, not shown. With the third auxiliary truss strap top hook, 300, hooked on to the main ring, 33, with the third auxiliary strap, 301, as it would wrap around an advantage point on the truss, not shown, the third auxiliary truss strap bottom hook, 302, hooked on to the third auxiliary strap, 301, creating a loop, 303 for the truss. With the forth auxiliary truss strap top hook, 400, hooked on to the main ring, 33, with the forth auxiliary strap, 401, as it would wrap around an advantage point on the truss, not shown, the fouith auxiliary truss strap bottom hook, 402, hooked on to the fourth auxiliary strap, 401, creating a loop, 403 for the truss. With the fifth auxiliary truss strap top hook, 500, hooked on to the main ring, 33, with the fifth auxiliary strap, 501, as it would wrap around an advantage point on the truss, not shown, the fifth auxiliary truss strap bottom hook, 502, hooked on to the fifth auxiliary strap, 501, creating a loop, 503 for the truss. The sixth strap, 601, in this illustration, has an extra large hook instead of a smaller hook. 11, to be attached directly to the truss with or without a loop. The straps are of different lengths and are numbered, 29, according to the length and sequence that the trusses would be attached and installed on the walls or roof, after it is wrapped around a rafter(s) (not shown) and hooked on to its own strap or directly to the trusses. Also additional straps, 36, could have an add on hook, 12 and there could be a main line, 6, with other straps attached to it, in any number or sequence and as a whole, and the ring, at times would employ any combination of different straps, 100, 101, 102, 103, 6. The longest strap would be attached to the first item that is to be installed on the walls or roof, or moved in any way with or without a sequence and the shortest auxiliary strap would be attached to the truss, rafter, or any other item to be installed with or without a sequence, that would be the last item to be installed. Also each strap would or would not have a storage loop, 27, with or without a safety cover, for storing the bottom hooks, after they have been detached from the truss, or can be attached to the main ring and stored there or left free. In this configuration, additional straps would be attached to the ring, clevis, or what ever other configuration or attaching apparatus of the member that the straps are attached to or any number would be removed as to the number of trusses there are to be installed at any given time. Also, additional straps could be added with the use of an add on extension strap, 36, that would carry the load for another set of main straps in some instances where adding on another main strap on to a main line would over stress the first main strap, thus distributing the weight over the entire ring more evenly. The, add on, extension strap would or would not have its own attachment points, 7 & 8, or be used only as an extension. The straps would be of different or equal lengths, expandable or not, to accommodate any size truss or item.

It is to be understood that this invention described herein does not limit its scope, adaptability and capabilities as many other variations can be created although not specifically mentioned here.

### SUMMERY

A construction installing strap that can lift a group of items, either on a single strap with the strap having multiple attachment points that have large hooks arranged in succession, equally spaced apart from each other or custom designed straps particular to each job, to attach to a truss, beams, or any type of items that need to be lifted and lowered down into position so they can be installed on a wall or roof in numerical order or there would be auxiliary straps on the attachment points of a main line or a main ring and these would rap around or be affixed in any safe way at the most advantageous locations on a truss, beams, or any type of items that need to be lifted and lowered down into position one after the other in a correct numerical order and in an orderly fashion, so as to greatly speed up the work of installation that it is safe and efficient.

I claim:

1. A single main strap with multiple auxiliary straps that are attached to the main strap for installing multiple roofing trusses or any other item at one time;

2. As per claim one, a single main strap with multiple auxiliary straps that are attached to the main strap that allows a crane operator to pick up a group of single or multiple roofing trusses or other items at one time and then lower these items to install them on the top of a wall or roof or any other place;

3. As per claim one, a single main strap with multiple auxiliary straps that are attached to the main strap that allows a crane operator to pick up and lower down in place these items, one after the other with them suspended at different levels so that the other items waiting to be installed in their on turn will not interfere or will not be in the way of the one that is being attached to the top of the walls or roof, instead of these items being raised and lowered down into position one at a time;

4. As per claim one, a main strap with multiple attaching points, placed on the main strap in succession, spaced apart at the most advantageous distance apart and from each other and at the most advantageous place on the main strap;

5. As per claim one, a single sling main strap with attachment points consisting of rings, hooks, or loops, either of the main strap, by having the main strap wrap around a ring, loop or hook or having another piece of material affixed to the main strap in such a way so as to create a loop to hold the ring, hook or loop;

6. As per claim one, a single main strap with multiple auxiliary straps that are attached to the main strap and the multiple auxiliary straps would have hooks or attaching hardware, at least one hook on each end of the auxiliary straps;

7. As per claim one, a single main strap with multiple auxiliary straps that are attached to the main strap and the auxiliary straps would be or would not be detachable;

8. As per claim one, a single main strap with multiple auxiliary straps that are attached to the main strap and the auxiliary straps would or would not have additional attachment points spaced up the auxiliary strap at the most advantageous points, in any needed number;

9. As per claim one, a single main strap that is a single strap on one end, then becomes a multiple main strap any where along its length with multiple auxiliary straps that are attached to the main strap or straps and the auxiliary strap attachment points would be in the form of a ring, hook, loop or clevis or any other attachable hardware;

10. As per claim one, a single main strap with multiple auxiliary straps that are attached to the main strap with the auxiliary straps to be affixed to at least one item that needs to be lifted, more than one at a time and lowered into place in numerical order;

11. As per claim one, a single main strap with multiple auxiliary straps that are attached to the main strap so that, yet, other auxiliary straps would or would not be attached to the first set of auxiliary straps with the second or more auxiliary straps to be affixed to an items that needs to be lifted, more than one at a time and lowered into place in numerical order;

12. As per claim one, a single main strap with multiple auxiliary straps that are attached to the main strap so that, yet, other auxiliary straps would or would not be attached to the first set of auxiliary straps where the first truss or item that is to be installed is actually picked up last and hangs the lowest on the main strap or combination of straps;

13. As per claim one, a main strap with a single or a multiple attaching auxiliary straps with hooks, at least one on each end of the strap and each strap is of a same or different lengths;

14. As per claim one, a main strap with multiple attaching auxiliary straps with hooks, at least one on each end of the auxiliary straps, and each strap is of a different number, texture and or color, each difference being significant as to a number or order;

15. As per claim one, a main strap with multiple attaching auxiliary straps with hooks, at least one on each end of the auxiliary straps, and each strap is of a different number, texture and or color, each difference being significant as to a number or order for the installer to distinguish one from the other so as to be able to determine the proper sequence that the trusses or any other objects are to be installed in;

16. As per claim one, a main strap with multiple attaching auxiliary straps with hooks, at least one on each end of the auxiliary straps, and each strap is of a different number, texture and or color, each difference being significant as to a number or order so that the workmen can properly identify and attach the proper main strap or auxiliary strap to the correct item, which ever would apply to the proper truss or item;

17. As per claim one, a single or multiple main straps with multiple attaching auxiliary straps with hooks, at least one hook or attaching mechanism on each end of the auxiliary straps, and each strap is of a different number, texture and or color, each difference being significant as to a number or order so that after a workmen has attached the items to the straps, they would be in correct sequence or numerical order and height on the main strap, or any combination of straps, when they are brought to the location where they are to be installed;

18. As per claim one, a main strap with multiple attaching auxiliary straps with hooks, at least one on each strap, arranged so that the suspended trusses or items are not directly over head of the installer when they are being attached to the top of the walls or roof and the next truss to be installed is on the far side of the truss or item that is being installed and attached to the top of the walls or roof;

19. As per claim one, at least one main strap with multiple attaching auxiliary straps with hooks, at least one on each strap, so that the trusses to be installed in sequence are hung one slightly higher than the previous one so that the next truss to be installed does not obstruct the installation of the truss that is being attached to the top of the walls or roof;

20. As per claim one, a main strap with multiple attaching auxiliary straps with hooks, at least one on each main or auxiliary strap, so that when the trusses are in the proper location on the top of the walls or roof, or at any location in or on the building, and the crane operator lowers the trusses or items, the lowest truss on the main strap or auxiliary straps or on the longest line, touches the top of the walls or roof first and can be installed without the next truss interfering with the first one or the one that is being installed;

21. As per claim one, a main strap with multiple attaching auxiliary straps on the main line with or without multiple straps on each additional auxiliary strap, each with its own hook(s), at least one on each strap;

22. As per claim one, a multiple truss lifting strap that allows workmen to lift, set and install multiple trusses or any other item in one lift and transporting operation.

23. As per claim one, a multiple truss lifting strap that allows at least one less workmen to install roofing trusses or any other items because when multiple items are lifted and installed, there would be enough work of installing the trusses on the top of the walls or roof, that one workmen would descend off the wall or roof, hook multiple trusses on to the lifting strap(s) and then it would be efficient enough or there would be enough items to be installed at the location of installation for that descended workman to, then, ascend the walls or roof and assist in installing the multiple trusses or any other item because the descending and ascending portion of the job would be reduced in number so that the workman would not become fatigued or that portion of the job would be reduced in number to make one workman able to accomplish the multiple tasks;

24. As per claim one, a multiple truss setting strap that would eliminate the time wasted when the crane operator spends swing the crane boom back and forth to pick up each and every truss;

25. As per claim one, a multiple truss setting strap that would have at least one additional loop or holding device so that after the installers finished securing the items on the wall, walls or roof, and he removes the hook(s) or attaching apparatus from the truss, there would be a place on the strap for the hook to be hooked to or be hooked to the main strap ring, if there was one, with or without safety device(s), or safety cover, so that after the trusses are installed, the used hooks would not become hooked on any obstacle so that when the crane operator lifts, lowers or moves the boom and or cable in any fashion, the stored hooks would not become clogged, or attached in any way to any other objects so as not to create a hazard and damage any installed work;

26. As per claim one, a multiple truss setting strap or straps, that would have a large hook shaped so as to be able to hook on to a truss or the hook and line would be passed under the truss support member and the hook attached to its own line or any advantageous location or object, creating a loop so that at least one truss would be lifted, or as many trusses as the workman deems necessary to be lifted at one time or the strap would terminate in a large hook or clamp, large enough to be attached directly to a truss, rafter or any other object to be lifted and set in place with or without numerical order;

27. As per claim one, a multiple truss setting strap that would have one or more hooks on each end of each straps, or the straps would terminate with at least one ring or loop or any other attachable hardware, where as a single or multiple hooks would be attached to the attachment ring or hardware on each strap allowing single or multiple trusses to be lifted on each strap that is in the multiple lifting strap arrangement;

28. As per claim one, a multiple truss setting strap that would have an additional second auxiliary straps on each first auxiliary strap, or a safety strap would be available so that the trusses would be held together and give stability to the multiple trusses that are suspended in the air where a breeze or high winds may otherwise cause the trusses to become unstable with additional loops for these to be attached to, single or multiple, on the main strap and or on the auxiliary straps, with or without a protective cover, at any advantageous location and or number, on the straps so that, once used, the hooks would not become clogged on any obstacle when the other operations are accomplished and would other wise create a hazard such as dislodging previously installed trusses or objects;

29. As per claim one, a multiple truss setting strap that would have additional attaching hardware so that additional safety ropes or cables would be attached to one or every or any straps so as to control the trusses when suspended in the wind or for back up safety in case a strap(s) breaks, for lighting in the dark and reflective materials and be made of nonconductive materials and or remote signal transfer equipment where the crane operator would or would not be able to operate the crane from a remote location, such as at the actual job site where the workmen on the walls or roof would be located to save time and be safer because the crane operator would be able to see exactly what operation was needed at any given time instead of by hand, voice, or any other signals;

30. As per claim one, a multiple truss setting strap that would have the auxiliary strap attachment points, sown, riveted or in other words, permanently attached to the main strap or the main straps would have rings or hooks permanently attached to it and the additional auxiliary straps would have hooks, or rings or any other attaching device, one on each end or anywhere along its length so as to allow for single or multiple straps on each main line ring and or auxiliary strap rings or attachment points and the straps would be interchangeable or replaceable in case of different job necessities or requirements, or in the case of wear on the straps;

31. As per claim one, a multiple truss setting strap that would have the main strap terminate in a ring, hook or loop or any other attachable hardware or configuration allowing additional main or auxiliary straps to be attached to the end, with the ends being single or plural and these attachment points be replaceable in case of wear or breakage with or with out extra safety cables incorporated into the weave of the fabric or be external or separate incase of breakage or over loading;

32. As per claim one, a multiple truss setting strap or straps that would have the ends of the main straps or any other auxiliary strap terminate in a ring or loop so that additional straps of the same or different types can be attached to it or any safety device or other lifting mechanism could be attached to it;

33. As per claim one, the auxiliary straps would have a first end as a ring, hook, loop or any other attachable means to attach itself to the main strap and a second end terminating in any attachable apparatus and any of the other auxiliary straps would or would not have multiple attachment points to facilitate the balancing and safety of the load, no matter what that load may be;

34. As per claim one, the main or auxiliary straps would or would not be adjustable as to length, structure, or capabilities so as to be adaptable to any load the workmen, or engineers deem necessary to complete any job for which the construction hoisting strap would be employed to as a lifting device;

35. As per claim one, a multiple truss setting strap that would be wired for camera(s), and or for conversing, warnings, or directions or for any useful purpose to the installers or to the crane operator in case of the line of site to the workmen or job location or of the crane operator is obstructed for any reason;

36. As per claim one, a multiple truss setting straps that would have loops located any where it would be most advantageous so that the installers on the walls or roof could operate an additional lifting or lowering mechanism, such as, but not limited to, a manually or electrically operated lifting or lowering device or mechanism any where along the main strap or on any of the auxiliary straps that the installers on the walls or roof or on the ground could lift or lower any item or combination of items in any necessary way;

37. As per claim one, a main strap with multiple attaching auxiliary straps with hooks, at least one on each end of the auxiliary straps, and the workmen would be able to swing the boom by any means as needed, saving time and be safer with out the need for hand or voice commands to the main crane operator;

38. As per claim one, a multiple truss setting strap that would have a rotate device to allow the load to be vertically pivotal for spinning the suspended trusses in order to orientate the trusses to the job application;

39. As per claim one, a multiple truss setting strap that would have tights indicating directions or warnings from the crane operator to the installers or visa versa as to right, left, up down, or sequence of order as to which truss should be installed next;

40. As per claim one, a multiple truss setting straps that the height difference between the trusses or items that are suspended would be significant enough so that the next truss to be installed above the one that is being attached to the top of the walls or roof does not to obstruct the installers in installing the one that they are working on;

41. As per claim one, a multiple truss setting strap that would have attachment points on the main strap so that single or multiple auxiliary straps on any main line attachment point, would be all of the same or different length, strength characteristics, or in any combination there of;

42. As per claim one, a multiple truss setting strap that would have multiple attachment points on the main straps and on any other auxiliary straps and they would or would not have multiple attachment points for stability of the load(s), trusses, rafters or any other object(s) of same or dissimilar size, weight, style, configuration, capabilities, characteristics or purposes;

43. As per claim one, a multiple truss setting strap that would or would not be expandable or retractable on any of its straps in any combination of straps and adjustability;

44. As per claim one, a multiple truss setting strap that would or would not allow for any combination of auxiliary straps to be attached to any attachment point on any strap;

45. As per claim one, a multiple truss setting strap that would terminate in a ring, loop, or hook so that other main lines, all with the same or dissimilar capabilities could be added on to the main strap for the same or any other advantageous purpose;

46. As per claim one, when a large ring is used, any combination of additional straps can and would be attached to the ring, either on the main ring, or line or added on to any other strap either as main line with multiple attachment points all along its length or attached at the end where there would be a hook, loop, ring or any other attachable device forming a device or attachable device that another line or lines could be attached to it or it would attach itself to other lines or moveable or stationary objects and would be employed to secure any load, under any weather, load or time conditions;

47. As per claim one, a main strap with a large ring with multiple straps with the same or different lengths and capabilities, each strap having at least one hook to be attached to a roofing truss, or any other item where lifting more than one object a at any one time is necessary to save time and man hours;

48. As per claim one, a lifting ring with multiple straps permanently attached or attachable or detachable, and if needed, straps that are for extending and expanding the capabilities of the ring by allowing the user to attach main straps or additional ring lifters down below the main body of trusses or item, with or without attachment points on the extension straps any where along their length;

49. As per claim one, a lifting ring with multiple straps permanently attached or attachable or detachable where as all of the straps on the ring are main line straps, no matter what the number, length, sequence, arrangement or characteristics of the straps or ring;

50. As per claim one, a lifting ring with multiple straps permanently attached or attachable or detachable and there would be a single or multiple rings, each with its own set of straps with their own characteristics, and added on items;

51. As per claim one, a workmen would have the crane operator lower the first truss down on to the top of the walls or root install the truss or item there, have the crane operator lower the next item into place with the workmen assisting in positioning the next item into its proper location, then the workmen, either attaches the next item without crossing the first item that he just installed or he can step over or through the truss or item and attach the next item then, with the next items that are still suspended in the air on the other side of the item that he is installing so that they would not be over his head.

52. All items in this preferred embodiment of this invention would be rated and tested as to capabilities for safety and to allow the workmen using this equipment to be able to ascertain the correct loads and capabilities to be placed on any give apparatus.
